(19) United States
(12) Patent Application Publication
(10) Pub. No.: US 2026/0029355 A1
(43) Pub. Date: Jan. 29, 2026

(54) RADIATION IMAGING APPARATUS WITH AUTO EXPOSURE CONTROL (AEC) FUNCTION AND MANUFACTURING METHOD

(71) Applicant: CANON KABUSHIKI KAISHA, Tokyo (JP)

(72) Inventor: KAITO UEHATA, Kanagawa (JP)

(21) Appl. No.: 19/275,284

(22) Filed: Jul. 21, 2025

(30) Foreign Application Priority Data
Jul. 25, 2024 (JP) 2024-119420

(51) Int. Cl. G01N 23/04

(52) U.S. Cl. CPC G01N 23/04; G01N 2223/306; G01N 2223/401; G01N 2223/408; G01N 2223/413; G01N 2223/501

(57) ABSTRACT

A radiation imaging apparatus is configured to detect a radiation dose in a light reception field selected from among a plurality of light reception fields. The radiation imaging apparatus includes a radiation detection panel including the plurality of light reception fields, each of which includes at least one radiation dose detection element, and a housing configured to accommodate the radiation detection panel and having an incident surface for receiving the radiation. A plurality of indicators is formed on the incident surface and arranged in a matrix pattern, each indicator of the plurality of indicators corresponding to a light reception field of the plurality of light reception fields A display format of a first indicator among the plurality of indicators is a first display format, and a display format of a second indicator among the plurality of indicators is a second display format different from the first display format.

### BACKGROUND

### Field of the Technology

The present disclosure relates to a radiation imaging apparatus. The radiation imaging apparatus is used as a medical diagnosis apparatus and a nondestructive inspection apparatus, such as an X-ray flat-panel detector.

### Description of the Related Art

There have been known radiation imaging apparatuses capable of capturing radiation images used in medical image diagnostics and nondestructive inspections. To image with an appropriate radiation dose, a technique referred to as auto exposure control (AEC) has been used in recent years. This technique functions by controlling irradiation and stopping it when the radiation dose received by an imaging unit reaches a predetermined threshold.

Japanese Patent Application Laid-open No. 2023-77929 discusses a radiation imaging apparatus with the AEC function. Further, Japanese Patent Application Laid-open No. 2023-77929 discusses an example in which light reception fields, which are regions for monitoring radiation doses, are subdivided into a large number of regions arranged in a matrix pattern, such as 3×5 grids.

When the light reception fields are subdivided into multiple regions, as discussed in Japanese Patent Application Laid-open No. 2023-77929, it is on the assumption that light reception field indicators, which correspond to the light reception fields, may also be subdivided. However, the subdivided light reception field indicators may appear visually complex, and thus, it is desirable that the visibility be improved.

### SUMMARY

The present disclosure is directed to providing a radiation imaging apparatus including light reception field indicators with improved visibility.

According to an aspect of the present disclosure, a radiation imaging apparatus configured to detect a radiation dose in a light reception field selected from among a plurality of light reception fields, the radiation imaging apparatus includes a radiation detection panel including the plurality of light reception fields, each of which includes at least one radiation dose detection element, and a housing configured to accommodate the radiation detection panel and having an incident surface for receiving the radiation, wherein a plurality of indicators is formed on the incident surface and arranged in a matrix pattern, each indicator of the plurality of indicators corresponding to a light reception field of the plurality of light reception fields, wherein a display format of a first indicator among the plurality of indicators is a first display format, and wherein a display format of a second indicator among the plurality of indicators is a second display format different from the first display format.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a radiation imaging system.

FIG. 2 is a perspective diagram illustrating an external appearance of a radiation imaging apparatus.

FIG. 3 is a sequence diagram illustrating an operation sequence of the radiation imaging system.

FIG. 4 is a diagram illustrating an example of an examination screen.

FIGS. 5A, 5B, 5C, and 5D are diagrams each illustrating an example of emphasizing the light reception field indicators.

FIGS. 6A, 6B, and 6C are diagrams each illustrating an example of coloring the light reception field indicators.

FIGS. 7A, 7B, and 7C are diagrams illustrating examples of de-emphasizing the light reception field indicators, hiding the light reception field indicators, and prioritizing the light reception field indicators, respectively.

FIGS. 8A and 8B are diagrams each illustrating an example of adding auxiliary lines to the light reception field indicators.

### DESCRIPTION OF THE EMBODIMENTS

Some exemplary embodiments of the present disclosure will be described. Like reference numerals refer to like components throughout the exemplary embodiments, and redundant descriptions will be omitted. Further, the configurations described in the exemplary embodiments can be changed and combined appropriately.

### <Radiation Imaging System>

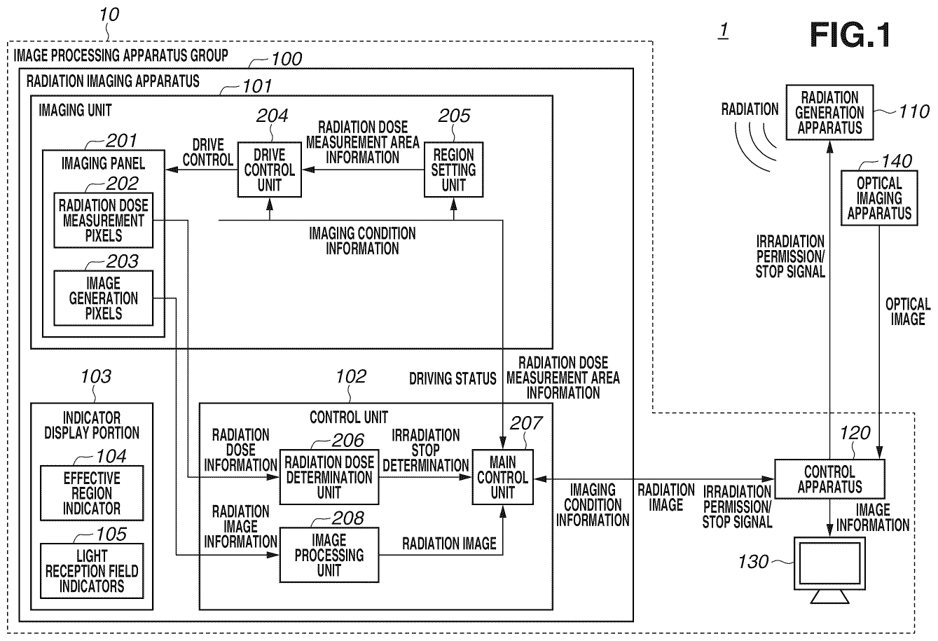

A first exemplary embodiment will now be described. The configuration of a radiation imaging system 1 (a radiographic image capturing system or a radiation detection system) will be described. FIG. 1 is a block diagram illustrating the configuration of the radiation imaging system 1.

The radiation imaging system 1 includes a radiation imaging apparatus 100, a radiation generation apparatus 110, a control apparatus 120, a display apparatus 130, and an optical imaging apparatus 140. In the radiation imaging system 1, the radiation imaging apparatus 100, the control apparatus 120, and the display apparatus 130 collectively correspond to an image processing apparatus group 10, which processes radiation images. The image processing apparatus group 10 is a group of devices, one of which performs image processing on radiation images. Specifically, the image processing can be performed either by the radiation imaging apparatus 100 or the control apparatus 120. Examples of the image processing include offset correction, sensitivity correction, spatial frequency processing, gradation processing, and defect correction.

The radiation imaging apparatus 100 generates radiation images based on the radiation emitted from the radiation generation apparatus 110.

The radiation generation apparatus 110 generates radiation. The radiation generation apparatus 110 includes an X-ray tube as a radiation source.

The display apparatus 130 is capable of displaying information. The display apparatus 130 displays an examination screen and the like used to manage the radiation imaging.

The optical imaging apparatus 140 is a camera capable of performing optical imaging. The optical imaging apparatus 140 can capture images of subjects as a target of the radiation imaging.

The control apparatus 120 is a communication apparatus that relays communications between the radiation imaging apparatus 100 and the radiation generation apparatus 110. The control apparatus 120 transmits imaging condition information to the radiation imaging apparatus 100 based on instructions input by users via a not-illustrated input unit and receives image information on the radiation images as imaging results. Further, the control apparatus 120 receives irradiation permission or stop signals from the radiation imaging apparatus 100 and outputs the irradiation permission or stop signals to the radiation generation apparatus 110. Communication between the control apparatus 120 and the radiation imaging apparatus 100, as well as between the control apparatus 120 and the radiation generation apparatus 110 may be either wireless or wired. For example, the wireless communication may be performed using a wireless local area network (LAN) based on Institute of Electrical and Electronics Engineers (IEEE) 802.11, and the wired communication may be performed using a wired LAN based on IEEE 802.3.

The control apparatus 120 receives optical images from the optical imaging apparatus 140, and outputs screen information to the display apparatus 130.

The control apparatus 120 also functions as an information processing apparatus that outputs examination screen information on the radiation imaging to the display apparatus 130. The control apparatus 120 outputs the radiation images received from the radiation imaging apparatus 100 to the display apparatus 130 as information on the examination screens. The control apparatus 120 transfers the radiation images to a server (not illustrated) of an in-hospital image management system, such as a picture archiving and communication system (PACS). Further, a single apparatus or a plurality of apparatuses may constitute the control apparatus 120.

The radiation imaging apparatus 100, the radiation generation apparatus 110, and the control apparatus 120 each have a control unit. Each control unit includes a central processing unit (CPU) as a calculation unit, and a read-only memory (ROM) and a random-access memory (RAM) as storage units. The CPU loads programs stored in the ROM into the RAM and runs the programs to carry out various kinds of functions.

### <Radiation Imaging Apparatus>

The configuration of the radiation imaging apparatus 100 will now be described.

The radiation imaging apparatus 100 (a radiographic image capturing apparatus or a radiation detection apparatus) generates radiation images based on the radiation emitted from the radiation generation apparatus 110. As illustrated in FIG. 1, the radiation imaging apparatus 100 broadly includes an imaging unit 101, a control unit 102, and an indicator display portion 103.

### <Imaging Unit>

The imaging unit 101 performs various kinds of processing to detect radiation.

The imaging unit 101 includes an imaging panel 201 (i.e., a radiation detection panel), a drive control unit 204, and a region setting unit 205. The imaging panel 201 includes image generation pixels 203 and radiation dose measurement pixels 202 (i.e., radiation dose detection pixels or radiation dose detection elements). The drive control unit 204 controls the driving of the imaging panel 201. The region setting unit 205 sets radiation dose measurement regions based on the imaging condition information received from the control unit 102.

The imaging panel 201 includes a two-dimensional array of pixels, each of which includes an imaging element that outputs radiation signals in response to incident radiation (incoming light), and the pixels are arranged in a two-dimensional plane region. A photoelectric conversion element in each pixel converts the light emitted by the phosphor—originally generated from the incident radiation—into an electrical charge (radiation signal). A capacitor of each pixel accumulates the radiation signals (the electric charge). Thallium-doped cesium iodide (CsI:Tl) or terbium-activated rare-earth oxysulfide phosphor (e.g., G₂O₂S:Tb), for example, can be used as the phosphor of the imaging panel 201.

The imaging panel 201 includes the pixels (the image generation pixels 203) that generate radiation images based on radiation transmitted through the subject and the pixels (the radiation dose measurement pixels 202) that measure the radiation dose (i.e., detect the radiation dose).

The image generation pixels 203 accumulate the radiation signals transmitted through the subject to generate radiation images. Radiation signals are periodically read from the radiation dose measurement pixels 202 during radiation imaging to monitor the radiation dose. The signals are read from the pixels of the imaging panel 201 under the control of the drive control unit 204. The image generation pixels 203 output radiation signals (radiation image information) to an image processing unit 208 of the control unit 102. Further, the radiation dose measurement pixels 202 output radiation signals (radiation dose information) to a radiation dose determination unit 206.

In this case, the image generation pixels 203 and the radiation dose measurement pixels 202 respectively include different signal lines and gate lines. This configuration allows the drive control unit 204 to independently drive the radiation dose measurement pixels 202 and the image generation pixels 203 at different timings. With the driving at different timings, pieces of information based on the accumulated radiation signals (the electric charge), such as the radiation image information and the radiation dose information, are output at different timings.

The arrangement of the image generation pixels 203 and the radiation dose measurement pixels 202 in the imaging panel 201 can be designed as appropriate. For example, a layer structure can be employed including a layer including a plurality of the image generation pixels 203 and a layer including a plurality of the radiation dose measurement pixels 202. The radiation dose measurement pixels 202 and the image generation pixels 203 can be arranged in a mixed manner on the same plane as that of the imaging panel 201.

The pixel configuration can be designed as appropriate. For example, a configuration can be employed in which one type of pixel (either the image generation pixels 203 or the radiation dose measurement pixels 202) is arranged so that each of the plurality of pixel regions arranged in an array has a single function. A single pixel region may be arranged to have multiple functions. Specifically, the structures of both the image generation pixels 203 and the radiation dose measurement pixels 202 may be integrated within a single pixel region. A pixel region having multiple functions may be applied to only some of the pixels arranged in an array, or it may be applied to all of them.

The drive control unit 204 generates a drive signal based on the imaging condition information received from the control unit 102 and outputs the drive signal to the imaging panel 201 to drive the imaging panel 201. The imaging condition information includes, for example, information on an imaging region (e.g., a chest region, an abdominal region, or a lumbar spine region), an imaging direction (e.g., posterior-to-anterior (PA) or anterior-to-posterior (AP), and frontal or lateral), subject information (e.g., a body size or whether the subject is a pediatric patient), and radiation dose measurement region information.

When the imaging condition information is input from the control unit 102 to the drive control unit 204, the drive control unit 204 generates drive control signals for the pixels of the imaging panel 201 (i.e., the radiation dose measurement pixels 202 and the image generation pixels 203). The drive control unit 204 performs a predetermined drive control on the image generation pixels 203. Under the predetermined drive control, the image generation pixels 203 accumulate radiation signals from the start to the end of a radiation exposure, and then output the accumulated radiation signals.

The region setting unit 205 sets a pixel region (a radiation dose measurement region) to be used in measuring the radiation dose based on the radiation dose measurement region information set by the user. The region setting unit 205 then outputs the radiation dose measurement region information to the drive control unit 204 and the control unit 102.

The drive control unit 204 identifies a pixel region of the radiation dose measurement pixels 202 to be used in the radiation dose measurement from among the plurality of radiation dose measurement pixels 202 arranged in the imaging panel 201 based on the radiation dose measurement region information obtained from the region setting unit 205. The drive control unit 204 performs driving of the identified pixel region of the radiation dose measurement pixels 202. With this driving, radiation dose monitoring processing with periodic readout is performed during radiation imaging.

### <Control Unit>

The control unit 102 controls the entire radiation imaging apparatus 100 and performs communication processing with an external device. The control unit 102 includes the radiation dose determination unit 206, a main control unit 207, and the image processing unit 208.

The main control unit 207 receives the imaging condition information from the control apparatus 120 and controls the imaging unit 101 based on the imaging condition information. The main control unit 207 receives a driving status output from the drive control unit 204. After power is supplied to the imaging panel 201, the drive control unit 204 checks output characteristics of the imaging panel 201 and thus performs a preparatory drive of the imaging panel 201 until the output characteristics of the imaging panel 201 become stable. While the output characteristics of the imaging panel 201 are not yet stable, the drive control unit 204 transmits to the main control unit 207 a driving status indicating that imaging is not possible. Once the output characteristics of the imaging panel 201 become stable, the drive control unit 204 transmits to the main control unit 207 a driving status indicating that imaging is ready. Further, the main control unit 207 communicates with the radiation generation apparatus 110 via the control apparatus 120 to transmit irradiation permission or a stop signal.

The radiation dose determination unit 206 determines whether to stop the irradiation based on the radiation dose information obtained from the radiation dose measurement pixels 202 and outputs the result to the main control unit 207. Specifically, the radiation dose determination unit 206 receives an integrated radiation dose value from the radiation dose measurement pixels 202 to compare the value with a preset radiation dose threshold. If the integrated value exceeds the radiation dose threshold, the radiation dose determination unit 206 outputs an irradiation stop determination signal to the main control unit 207 of the control unit 102. The control unit 102 controls the radiation generation apparatus 110 to stop the irradiation based on the comparison result between the integrated radiation dose value measured by the pixels in the pixel region and the preset threshold. For example, the control unit 102 controls the radiation generation apparatus 110 to stop the irradiation when the integrated value exceeds the threshold.

The image processing unit 208 outputs processed images based on the radiation image information received from the image generation pixels 203.

### <Indicator Display Unit>

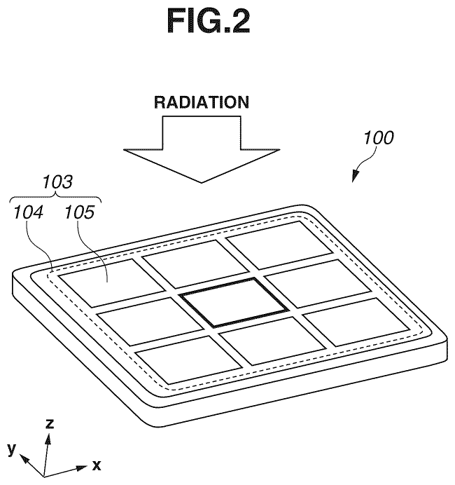

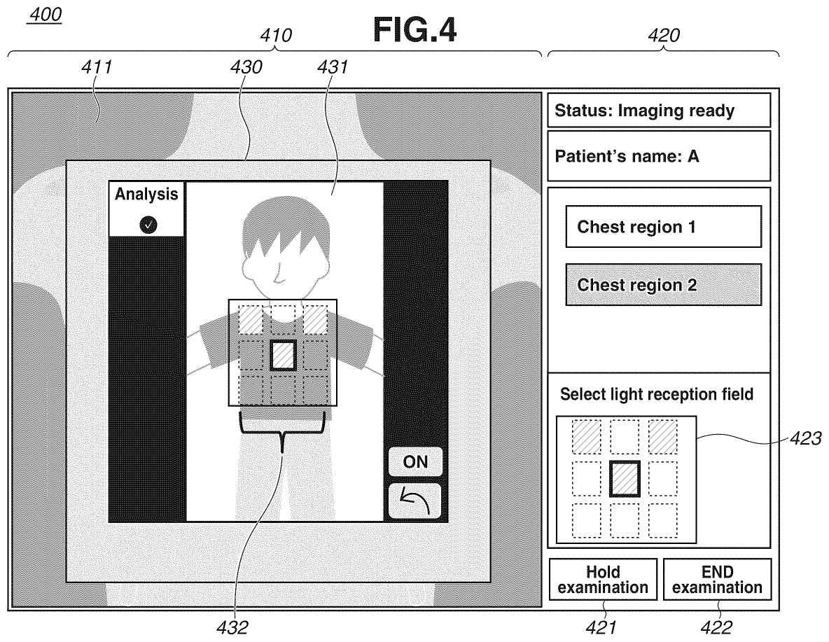

The indicator display portion 103 will now be described with reference to FIGS. 2 and 4. FIG. 2 is a perspective diagram illustrating an external appearance of the radiation imaging apparatus 100. FIG. 4 is a diagram illustrating an example of an examination screen.

As illustrated in FIG. 2, the radiation imaging apparatus 100 includes a box-shaped (a substantially rectangular parallelepiped) housing (i.e., outer cover) that accommodates the imaging panel 201. From among a plurality of surfaces constituting the housing of the radiation imaging apparatus 100, a surface that receives incident radiation is referred to as an incident surface (a front surface). The indicator display portion 103 is provided on the incident surface.

The indicator display portion 103 is a display indicator provided on the radiation imaging apparatus 100. The indicator display portion 103 includes an effective region indicator 104 and light reception field indicators 105. The effective region indicator 104 indicates a region with the image generation pixels 203 arranged thereon. The light reception field indicators 105 are a plurality of indicators that represent regions corresponding to groups (units of control) of the radiation dose measurement pixels 202.

These indicators are directly printed on the radiation incident surface of the imaging unit 101. However, in regions where the indicators overlap, such as at intersection points, overlapping coating material layers may lead to partial reduction in radiation transmittance. The partial reduction in radiation transmittance negatively affects the quality of a radiation image. Thus, in printing each indicator, it is preferable to adjust overlapping regions so that the coating material is applied in a single layer.

The light reception field indicators 105 can be used as a reference when the subject and the radiation imaging apparatus 100 are aligned. Thus, it is desirable that the visibility of the plurality of light reception field indicators 105 be considered to facilitate the alignment. The visibility enhancement of the light reception field indicators 105 will be described in detail below.

As illustrated in FIG. 4, the examination screen used to manage the radiation imaging displays indicators similar to those of the indicator display portion 103. The indicators displayed on the examination screen can be used as information for assisting an alignment between the subject and the radiation imaging apparatus 100.

During radiation imaging, an examination screen 400 is displayed as the graphical user interface (GUI) of an imaging management application.

The examination screen 400 includes an image display region 410 and an information display region 420.

The information display region 420 displays examination information and the like. Examples of the information included in the information display region 420 include imaging status information, patient information, and imaging protocol information. Further, the information display region 420 also displays light reception field selection information 423, an examination hold button 421, and an examination end button 422.

The light reception field selection information 423 displays the status of a currently selected light reception field. In FIG. 4, hatched regions represent the selected light reception fields from among the plurality of light reception fields shown in the light reception field selection information 423. The selected light reception fields are used in determining an auto exposure control (AEC) during the next radiation imaging. The light reception fields to be selected can be changed by performing a click operation, a touch operation, or the like on the light reception field selection information 423. As the selected light reception fields are changed, the selection status displayed in the light reception field selection information 423 is changed. Specifically, when the settings of the light reception fields are changed via the control apparatus 120, the light reception field information (the radiation dose measurement region information) is transmitted to the radiation imaging apparatus 100. The radiation imaging apparatus 100 updates the settings of the light reception fields based on the obtained light reception field information.

Then, the radiation imaging apparatus 100 responds to the control apparatus 120 with the updated light reception field information. The control apparatus 120 updates the display of the light reception field selection information 423 to the latest status based on the response.

The image display region 410 mainly displays a radiographic image 411. The user performs diagnosis of the subject based on the radiographic image 411 displayed after the radiation imaging.

In a situation where the system is awaiting the next imaging, an optical image window 430 is superimposed on the image display region 410. The optical image window 430 displays an optical image 431 that allows the current state of the subject to be visually recognized as an optical image obtained from the optical imaging apparatus 140. A light reception field marker 432 is superimposed on the optical image 431.

The light reception field marker 432 is displayed in a manner that follows a position corresponding to the detection position of the subject detected by the radiation imaging apparatus 100. Thus, the user can adjust the position of the subject to align with the light reception fields to be used. Alternatively, the light reception field marker 432 may be superimposed in a manner that follows the subject. By adjusting the position of the radiation imaging apparatus 100 to align with the position of the light reception field marker 432, the user can optimally adjust the position of a light reception field. The processing can be performed, for example, by performing image recognition processing on the optical image to detect the subject or the radiation imaging apparatus 100.

The light reception field marker 432 can be superimposed on the radiographic image 411 instead of the optical image 431. Thus, the control apparatus 120 (a display control unit) can display on the display apparatus 130 an image subjected to the image processing and the set light reception fields in a superimposed manner. By performing such output control (i.e., display control), the user can determine whether the radiation dose measurement region is appropriately set with respect to the imaging region based on the output (the displayed) image. The light reception field marker 432 can be used for comparison with previously captured images under the similar conditions.

In FIG. 4, the light reception field selection information 423 and the light reception field marker 432 are information used in comparison with (reference to) the light reception field indicators 105 provided on the radiation imaging apparatus 100. Thus, it is desirable that the display of the light reception field selection information 423 and the light reception field marker 432 reflect the actual visual characteristics of the light reception field indicators 105. For example, from among the light reception field indicators 105 in FIG. 2, the central light reception field indicator is displayed with a bold frame. Thus, it is desirable that the light reception field selection information 423 and the light reception field marker 432 be displayed with similar visual characteristics to the characteristics of the light reception field indicators 105.

### <Operation Sequence>

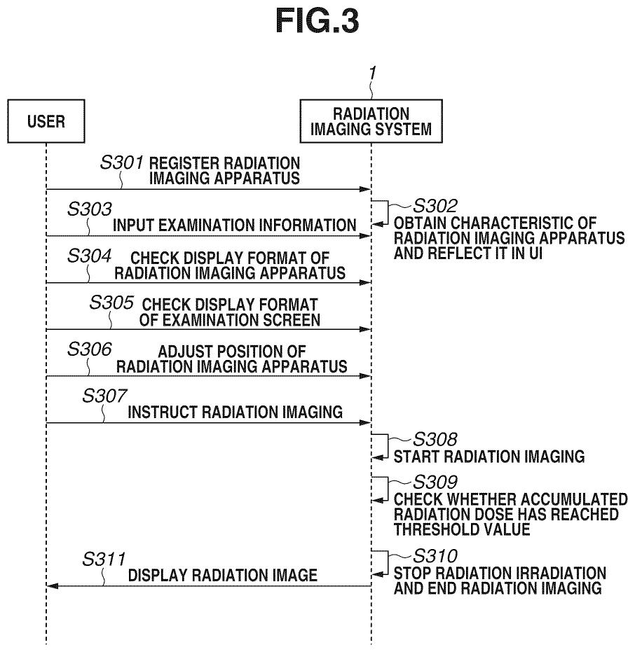

The operation sequence of the radiation imaging system 1 will now be described with reference to FIG. 3. FIG. 3 is a diagram illustrating an operation sequence of the radiation imaging system 1.

In step S301, the user registers the radiation imaging apparatus 100 in the radiation imaging system 1. This operation enables the radiation imaging apparatus 100 to access a network communicable with the radiation generation apparatus 110.

In step S302, the control apparatus 120 obtains identification (ID) information on the registered radiation imaging apparatus 100 and performs reflection processing on the examination screen so that the UI matches the functions and characteristics of the radiation imaging apparatus 100. The characteristics of the radiation imaging apparatus 100 include the light reception field indicators 105. Specifically, the light reception field selection information 423 and the light reception field marker 432 are switched to corresponding display formats that match the display format of the light reception field indicators 105 of the radiation imaging apparatus 100.

In step S303, the user inputs examination information via the examination screen. The examination information includes selection information on the light reception fields (radiation dose management pixel regions). A selection of the light reception field may be made by choosing from preset light reception field selection information stored in the radiation imaging apparatus 100 or based on a custom combination. The selected light reception field information is input to the drive control unit 204 and the region setting unit 205 from the control apparatus 120 via the main control unit 207.

The user performs an alignment operation of positioning the imaging region of the subject with respect to the imaging unit 101.

In step S304, the user checks the light reception field indicators 105 provided on the radiation imaging apparatus 100 to find out the installation orientation or the like of the radiation imaging apparatus 100.

In step S305, the user checks the examination screen (a display screen) displayed on the display apparatus 130 to find out the ideal installation position and orientation of the radiation imaging apparatus 100.

In step S306, the user adjusts the installation position of the radiation imaging apparatus 100 relative to the subject based on the comparison in steps S304 and S305 and completes the installation.

In step S307, the user instructs the radiation generation apparatus 110 and the radiation imaging apparatus 100 to start radiation imaging by using an exposure button (not illustrated) or the like.

In step S308, the radiation imaging apparatus 100 starts radiation imaging.

In step S309, the radiation imaging apparatus 100 checks whether the accumulated radiation dose in the selected light reception fields has reached the threshold.

In step S310, the radiation imaging apparatus 100 outputs a radiation stop signal if the accumulated radiation dose in the selected light reception fields has reached the threshold. Upon receiving the signal, the radiation generation apparatus 110 stops the radiation emission. When the radiation imaging is completed, the radiation imaging apparatus 100 transmits the radiation image to the control apparatus 120.

In step S311, the control apparatus 120 causes the display apparatus 130 to display the examination screen including information on the radiation image. The control apparatus 120 can cause the display apparatus 130 to display the radiation dose measurement region information obtained from the main control unit 207 and the image subjected to the image processing (i.e., the processed image) in a superimposed manner. This allows the user to confirm the alignment of the imaging region of the subject with the radiation dose measurement region.

### <Improvement of Light Reception Field Indicator>

An improvement method for the light reception field indicators will now be described. In order to enable the AEC function to accommodate various imaging conditions, it is desirable that a plurality of light reception fields be provided over a wide range. As a method of providing a large number of light reception fields, it is assumed that the light reception fields are arranged in a matrix-like (grid or two-dimensional) pattern. In this case, the matrix-like pattern refers to a configuration in which figures or markers are arranged in a generally regular pattern both vertically and horizontally. The light reception field arranged in a matrix-like (grid) pattern is, for example, a light reception field group having at least a 3×3 array. A configuration in which some light reception fields are arranged irregularly or some portions of the matrix are missing can be included. As described above, by arranging the light reception fields in a matrix-like manner, it is possible to achieve multi-region coverage and fine segmentation of the light reception fields. However, as the light reception fields become more segmented and cover more regions, it becomes increasingly difficult to determine which light reception field indicator of the radiation imaging apparatus 100 is indicated by the light reception field indicator displayed on the display apparatus 130. Thus, it is desirable that the light reception field indicator 105 have a feature to enhance the visibility. In the present exemplary embodiment, an example will be described where the visibility is improved by using two or more different line thicknesses.

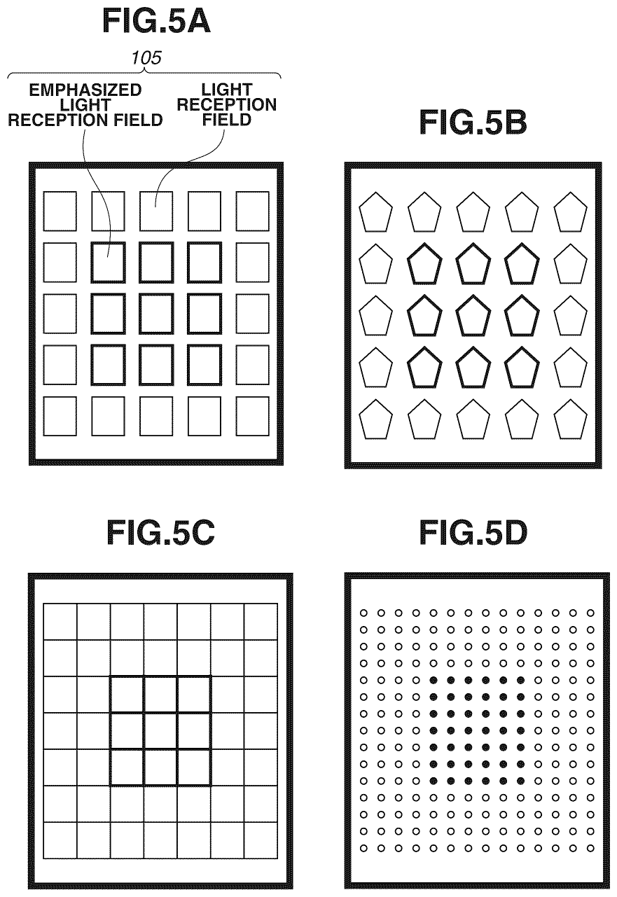

FIG. 5A illustrates an example of emphasizing the light reception field indicators. In FIG. 5A, the rectangular light reception field indicators 105 are arranged in a matrix pattern at predetermined intervals. In FIG. 5A, some of the light reception field indicators (emphasized light reception fields) disposed in a central region (near the center), which are used as the alignment references, are depicted with thick lines. The other light reception field indicators (normal light reception fields) are depicted with thin lines. As described above, by varying the line widths of the plurality of light reception field indicators, the visibility of the light reception field indicators used as the alignment references can be improved. In this example, the two levels of line width, i.e., thick and thin, are used to distinguish between the indicators. However, the light reception field indicators can be distinguished using more (i.e., three or more) line width types.

### Modification Example

The rectangular light reception field indicators are used as an example in FIG. 5A, but the shapes of the light reception field indicators can be other frame shapes. Geometric figures can be employed as the frame shapes.

FIGS. 5B to 5D each illustrate another example of emphasizing the light reception field indicators.

In FIG. 5B, a pentagonal shape is employed as the light reception field indicators 105. By using an asymmetric shape in the vertical direction (i.e., a non-point-symmetric shape), the user can recognize the installation orientation of the radiation imaging apparatus 100 based on the orientation of the light reception field indicators 105. Alternatively, other non-point-symmetric shapes, such as shapes that are asymmetric in the horizontal direction, can be used. The shape of the light reception field indicators 105 is not limited to a polygon and can be any other pentagonal shape.

In FIG. 5C, the light reception field indicators 105 are employed whose region is divided into a checkerboard pattern. With a high placement density of the light reception field indicators 105, using such a shape can reduce the total number of lines required.

In FIG. 5D, the light reception field indicators 105 are employed as circular dots arranged in a matrix pattern. In this example, each dot (a non-frame-shaped figure) represents the center position (i.e., the representative position) of a light reception field. With a high placement density of the light reception fields, employing such a shape can improve the visibility.

Instead of using substantially circular dots, a symbolic shape, such as a cross or star mark, may be employed. Alternatively, a plurality of kinds of marks can be used in combination.

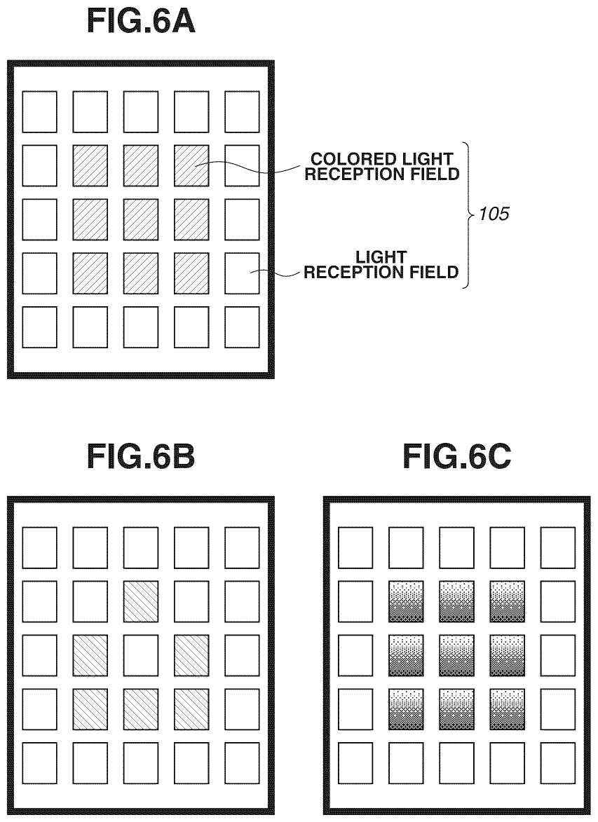

A second exemplary embodiment will now be described. In the present exemplary embodiment, an example will be described where the visibility is improved by presence and absence of coloring. FIG. 6A illustrates an example of coloring the light reception field indicators.

In FIG. 6A, the interiors of the light reception field indicators in the central portion used as the alignment references (colored light reception fields) are colored. On the other hand, the other light reception field indicators (the normal light reception fields) are not colored. In this manner, varying the fill pattern of colored or not colored (filled or not filled) among the plurality of light reception field indicators 105 can improve the visibility of the light reception field indicators used for alignment. In this example, the light reception field indicators are distinguished using two levels, i.e., colored or not colored. However, the light reception field indicators 105 can be divided into three or more types by varying attributes, such as hues, saturation, and brightness.

### Modification Example

In FIG. 6A, an example is described where the light reception field indicators in the central portion are filled with a single color, but other coloring methods can be employed. FIGS. 6B and 6C each illustrates another example of coloring the light reception field indicators.

In FIG. 6B, the colored light reception field indicators 105 are arranged in a vertically asymmetric manner. This allows the orientation of the radiation imaging apparatus 100 to be recognized simply by the user's viewing of the light reception field indicators 105.

In FIG. 6C, the interior region of a light reception field indicator 105 is colored to produce a vertically asymmetric shading (gradation). By changing the fill pattern in this manner, the orientation of the radiation imaging apparatus 100 can be identified simply by the user's viewing of the light reception field indicators 105.

A third embodiment will now be described. In the present exemplary embodiment, an example will be described where the visibility is improved by de-emphasizing some of the light reception field indicators 105.

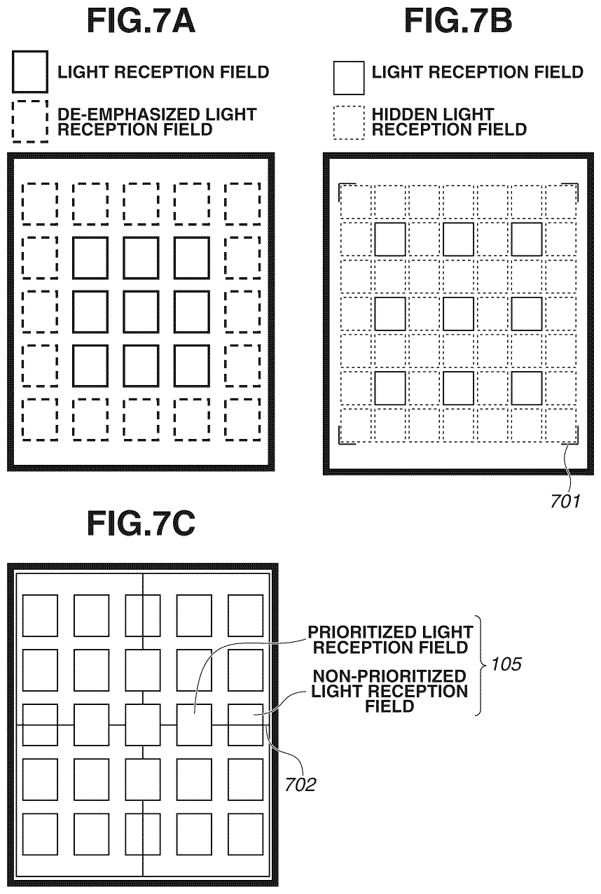

FIG. 7A illustrates an example where some of the light reception field indicators are de-emphasized. In FIG. 7A, the rectangular light reception field indicators 105 are arranged in a matrix pattern. Some of the light reception field indicators (the normal light reception fields) in the central portion used as the alignment reference are depicted with solid lines. The other light reception field indicators (non-emphasized light reception fields) are depicted with broken lines. By differentiating the line types of the plurality of light reception field indicators in this manner, the visibility of the light reception field indicators used for alignment can be improved. In this example, the two types of lines, i.e., the solid line and the broken line, are used to distinguish between the indicators, but more (i.e., three or more) line types can be used to distinguish among the light reception field indicators.

### Modification Example

In FIG. 7A, the method of distinguishing between the light reception field indicators using broken lines and solid lines is employed. However, other methods can be used to distinguish between the light reception field indicators.

FIG. 7B illustrates an example where some of the light reception field indicators are hidden. FIG. 7C illustrates an example where some of the light reception field indicators are prioritized.

In FIG. 7B, while some of the light reception field indicators are displayed, the other light reception field indicators are hidden. The dotted lines representing the hidden light reception fields in FIG. 7B indicate that no actual lines are rendered. In this case, the hidden light reception fields refer to the light reception fields for which the light reception field indicators 105 are not displayed, but the light reception fields (interior light reception fields) are still selectable on the examination screen 400.

All the light reception fields of the light reception field indicators 105 selectable by the user do not necessarily need to be displayed.

Thus, with a high placement density of the light reception fields or another condition, omitting the display of some of the light reception field indicators can reduce the visual complexity of the light reception field indicators 105. Further, in a case where the interior light reception fields are arranged in a wider area than that of the displayed light reception fields, the outermost boundary of the interior light reception fields can be indicated using markers 701. In this manner, hiding some of the light reception field indicators can improve the visibility of the light reception field indicators used as the alignment reference.

FIG. 7C illustrates an example where the display formats of the light reception field indicators are differentiated based on the presence or absence of other indicators within the light reception field indicators. Examples of the other indicators include central indicators 702. The indicators of the prioritized light reception fields refer to light reception field indicators that are displayed with higher priority than the central indicators 702. Thus, within a region of the prioritized light reception field indicators, the central indicator 702 is not superimposed. On the other hand, the indicators in the non-prioritized light reception fields are displayed with lower priority than the central indicators 702. Thus, the central indicators 702 are superimposed within the regions of the non-prioritized light reception fields. These relationships can be interpreted as layered structures. Specifically, the indicators of the prioritized light reception fields are arranged in front of the central indicators 702, while the indicators of the non-prioritized light reception fields are arranged behind the central indicators 702. By differentiating whether the central indicators 702 are superimposed, the visibility of the light reception field indicators used as the alignment reference can be improved.

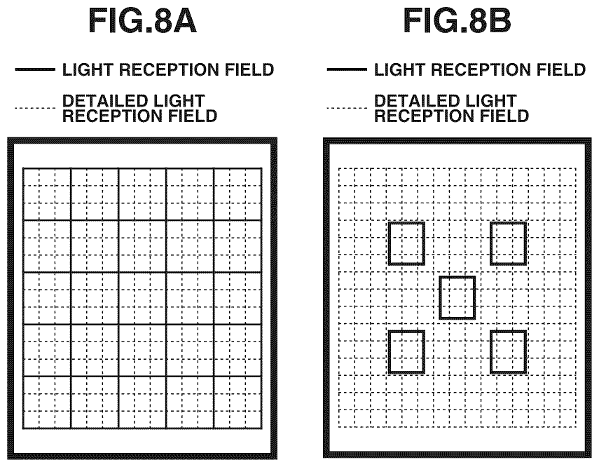

A fourth exemplary embodiment will now be described. In the present exemplary embodiment, an example will be described where the visibility of the light reception field indicators is improved by representing a detailed light reception field in each of the light reception fields. FIG. 8A illustrates an example of providing auxiliary lines in each of the light reception field indicators.

In FIG. 8A, in addition to the grid lines arranged in a matrix pattern that indicate the detailed light reception fields, the light reception field indicators 105 are provided to group a plurality of the detailed light reception fields. The light reception field indicators 105 provided in this manner of grouping (or bundling) the detailed light reception fields, which are numerous and individually have low visibility, allow the overall visibility to be improved. Specifically, the light reception field indicators 105 are superimposed on the matrix-patterned grid lines. This configuration makes it possible to identify the positions of the representative light reception fields used under standard settings, as well as the positional relationships of the detailed light reception fields.

For example, the control apparatus 120 can receive the standard light reception field settings via the examination screen. In the standard light reception field settings, a light reception field to be used for radiation imaging is selected from a 5×5 grid. Further, the control apparatus 120 can receive detailed light reception field settings via the examination screen. In the detailed light reception field settings, a light reception field to be used for radiation imaging is selected from a 15×15 grid. In other words, as illustrated in FIG. 8A, each standard light reception field has nine light reception fields for the detailed settings. In this case, it is desirable to improve the visibility by differentiating the line width, the line type, or the line color between the lines of the light reception field indicators 105 and the auxiliary lines. For example, it is desirable to use thick lines for the light reception field indicators 105, and thin lines for the auxiliary lines to improve the visibility.

### Modification Example

FIG. 8B illustrates another example of providing auxiliary lines (grid lines) in the light reception field indicators.

In FIG. 8B, the light reception field indicators 105 are provided independently of the matrix-patterned grid lines indicating the detailed light reception fields. Such light reception field indicators are employed in the radiation imaging apparatus 100 to allow for flexible design of the light reception fields. As described above, a light reception field indicator 105 enclosing a region where a plurality of the detailed light reception fields, which are numerous and low in visibility, are arranged can improve the overall visibility. In this case, it is desirable to improve the visibility by differentiating the line width, the line type, or the line color between the lines of the light reception field indicators 105 and the matrix-patterned grid lines. For example, it is desirable to use thick lines for the light reception field indicators 105 and thin lines for the matrix-patterned grid lines to improve the visibility.

### Other Embodiments

The present disclosure has been described with reference to the exemplary embodiments, but the present disclosure is not limited thereto. Modifications without departing from the spirit of the present disclosure, and disclosures equivalent to the present disclosure are encompassed within the scope of the present disclosure. For example, not all the combinations of the features described in the above exemplary embodiments are necessarily essential to solving means to the present disclosure. As long as the effects of the present disclosure can be obtained, some features may be substituted or omitted. Further, the dimensions, the materials, the shapes, and the relative positions of the components described in the exemplary embodiments are merely examples and can be changed depending on the conditions. The exemplary embodiments and the modification examples can be appropriately combined within the range not departing from the spirit of the present disclosure. The above exemplary embodiments discuss the apparatus itself, as well as the method for manufacturing the apparatus.

In the present specification, the term radiation includes, for example, X-rays, α-rays, β-rays, γ-rays, particle beams, and cosmic rays.

### APPENDIX

The present specification includes the following disclosure.

### [Appendix 1]

A radiation imaging apparatus configured to detect a radiation dose in a light reception field selected from among a plurality of light reception fields, the radiation imaging apparatus comprising:
a radiation detection panel including the plurality of light reception fields, each of which includes at least one radiation dose detection element; and
a housing configured to accommodate the radiation detection panel and having an incident surface for receiving the radiation,
wherein a plurality of indicators is formed on the incident surface and arranged in a matrix pattern, each indicator of the plurality of indicators corresponding to a light reception field of the plurality of light reception fields,
wherein a display format of a first indicator among the plurality of indicators is a first display format, and
wherein a display format of a second indicator among the plurality of indicators is a second display format different from the first display format.

### [Appendix 2]

The radiation imaging apparatus according to appendix 1, wherein the second display format is different from the first display format in at least one of line type, line width, hue, saturation, brightness, or fill pattern.

### [Appendix 3]

The radiation imaging apparatus according to appendix 1 or 2, wherein the first indicator is positioned at a center of the incident surface or nearer to the center than the second indicator, and wherein the first display format is higher in visibility than the second display format.

### [Appendix 4]

The radiation imaging apparatus according to any one of appendixes 1 to 3, wherein the incident surface further includes an indicator indicating an outline of a region in which the plurality of light reception fields is arranged.

### [Appendix 5]

The radiation imaging apparatus according to appendix 1, wherein the plurality of indicators is represented by frame-shaped figures arranged in a matrix pattern at intervals.

### [Appendix 6]

The radiation imaging apparatus according to appendix 5, wherein the frame-shaped figures are geometric figures.

### [Appendix 7]

The radiation imaging apparatus according to appendix 6, wherein the geometric figures are polygonal figures.

### [Appendix 8]

The radiation imaging apparatus according to appendix 7, wherein the polygonal figures are rectangular figures.

### [Appendix 9]

The radiation imaging apparatus according to appendix 5, wherein the frame-shaped figures are non-point-symmetrical figures.

### [Appendix 10]

The radiation imaging apparatus according to any one of appendixes 1 to 4, wherein each indicator of the plurality of indicators corresponds to a representative position of a light reception field.

### [Appendix 11]

The radiation imaging apparatus according to appendix 10, wherein the plurality of indicators is represented by a plurality of non-frame-shaped figures arranged in a matrix pattern at intervals.

### [Appendix 12]

The radiation imaging apparatus according to appendix 11, wherein the non-frame-shaped figures are dots.

### [Appendix 13]

The radiation imaging apparatus according to appendix 11, wherein the non-frame-shaped figures are symbol-shaped figures.

### [Appendix 14]

The radiation imaging apparatus according to appendix 10, wherein the representative position of the light reception field is the center position of the light reception field.

### [Appendix 15]

The radiation imaging apparatus according to any one of appendixes 1 to 3, wherein the plurality of indicators is represented by regions divided in a checkerboard pattern.

### [Appendix 16]

A manufacturing method for a radiation imaging apparatus configured to detect a radiation dose in a light reception field selected from among a plurality of light reception fields, and including a radiation detection panel including the plurality of light reception fields, each of which includes at least one radiation dose detection element, and a housing configured to accommodate the radiation detection panel and having an incident surface for receiving an incidence of the radiation, the manufacturing method comprising:
forming, on the incident surface, a plurality of indicators corresponding to the plurality of light reception fields and arranged in a matrix pattern,
wherein a display format of a first indicator among the plurality of indicators is a first display format, and
wherein a display format of a second indicator among the plurality of indicators is a second display format different from the first display format.

### [Appendix 17]

A radiation imaging apparatus configured to detect a radiation dose in a light reception field selected from among a plurality of light reception fields, the radiation imaging apparatus comprising:
a radiation detection panel including the plurality of light reception fields, each of which includes at least one radiation dose detection element; and
a housing configured to accommodate the radiation detection panel and having an incident surface for receiving an incidence of the radiation,
wherein a plurality of indicators is formed on the incident surface and arranged in a matrix pattern, the plurality of indicators corresponding to the plurality of light reception fields,
wherein a display format of a first indicator among the plurality of indicators is a first display format, and
wherein a display format of a second indicator grouping some of the plurality of indicators is a second display format different from the first display format.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-119420, filed Jul. 25, 2024, the entirety of which is incorporated herein by reference.

What is claimed is:

1. A radiation imaging apparatus configured to detect a radiation dose in a light reception field selected from among a plurality of light reception fields, the radiation imaging apparatus comprising:
a radiation detection panel including the plurality of light reception fields, each of which includes at least one radiation dose detection element; and
a housing configured to accommodate the radiation detection panel and having an incident surface for receiving the radiation,
wherein a plurality of indicators is formed on the incident surface and arranged in a matrix pattern, each indicator of the plurality of indicators corresponding to a light reception field of the plurality of light reception fields,
wherein a display format of a first indicator among the plurality of indicators is a first display format, and
wherein a display format of a second indicator among the plurality of indicators is a second display format different from the first display format.

2. The radiation imaging apparatus according to claim 1, wherein the second display format is different from the first display format in at least one of line type, line width, hue, saturation, brightness, or fill pattern.

3. The radiation imaging apparatus according to claim 1,
wherein the first indicator is positioned at a center of the incident surface or nearer to the center than the second indicator, and
wherein the first display format is higher in visibility than the second display format.

4. The radiation imaging apparatus according to claim 1, wherein the incident surface further includes an indicator indicating an outline of a region in which the plurality of light reception fields is arranged.

5. The radiation imaging apparatus according to claim 1, wherein the plurality of indicators is represented by frame-shaped figures arranged in a matrix pattern at intervals.

6. The radiation imaging apparatus according to claim 5, wherein the frame-shaped figures are geometric figures.

7. The radiation imaging apparatus according to claim 6, wherein the geometric figures are polygonal figures.

8. The radiation imaging apparatus according to claim 7, wherein the polygonal figures are rectangular figures.

9. The radiation imaging apparatus according to claim 5, wherein the frame-shaped figures are non-point-symmetrical figures.

10. The radiation imaging apparatus according to claim 1, wherein each indicator of the plurality of indicators corresponds to a representative position of a light reception field.

11. The radiation imaging apparatus according to claim 10, wherein the plurality of indicators is represented by a plurality of non-frame-shaped figures arranged in a matrix pattern at intervals.

12. The radiation imaging apparatus according to claim 11, wherein the non-frame-shaped figures are dots.

13. The radiation imaging apparatus according to claim 11, wherein the non-frame-shaped figures are symbol-shaped figures.

14. The radiation imaging apparatus according to claim 10, wherein the representative position of the light reception field is the center position of the light reception field.

15. The radiation imaging apparatus according to claim 1, wherein the plurality of indicators is represented by regions divided in a checkerboard pattern.

16. A manufacturing method for a radiation imaging apparatus configured to detect a radiation dose in a light reception field selected from among a plurality of light reception fields, and including a radiation detection panel including the plurality of light reception fields, each of which includes at least one radiation dose detection element, and a housing configured to accommodate the radiation detection panel and having an incident surface for receiving an incidence of the radiation, the manufacturing method comprising:
forming, on the incident surface, a plurality of indicators corresponding to the plurality of light reception fields and arranged in a matrix pattern,
wherein a display format of a first indicator among the plurality of indicators is a first display format, and
wherein a display format of a second indicator among the plurality of indicators is a second display format different from the first display format.

17. A radiation imaging apparatus configured to detect a radiation dose in a light reception field selected from among a plurality of light reception fields, the radiation imaging apparatus comprising:
a radiation detection panel including the plurality of light reception fields, each of which includes at least one radiation dose detection element; and
a housing configured to accommodate the radiation detection panel and having an incident surface for receiving an incidence of the radiation,
wherein a plurality of indicators is formed on the incident surface and arranged in a matrix pattern, the plurality of indicators corresponding to the plurality of light reception fields,
wherein a display format of a first indicator among the plurality of indicators is a first display format, and
wherein a display format of a second indicator grouping some of the plurality of indicators is a second display format different from the first display format.
